(19) United States
(12) Patent Application Publication
(10) Pub. No.: US 2014/0218280 A1
(43) Pub. Date: Aug. 7, 2014

(54) PERIPHERAL DEVICE WITH MULTI-TRANSMISSION CAPABILITY

(71) Applicant: Pixart Imaging Inc., Hsin-Chu (TW)

(72) Inventors: YEN-CHANG WANG, Hsin-Chu (TW); Chun-Wei Chen, Hsin-Chu (TW); Ching-Lin Chung, Hsin-Chu (TW)

(73) Assignee: Pixart Imaging Inc., Hsin-Chu (TW)

(21) Appl. No.: 14/057,121

(22) Filed: Oct. 18, 2013

(30) Foreign Application Priority Data
Feb. 4, 2013 (TW) 102104281

(51) Int. Cl. G06F 3/01; G06F 3/033; G06F 3/023

(52) U.S. Cl. CPC G06F 3/01; G06F 3/0231; G06F 3/033
USPC 345/156

(57) ABSTRACT

The present disclosure provides a wireless peripheral device with multi-transmission capability. The wireless peripheral device wirelessly transmits a control signal to a wireless receiver. The wireless peripheral device comprises a first wireless transmitting unit, a second transmitting unit, and a processing unit. The second transmitting unit receives a responding signal from the wireless receiver. The capable transmission distance of the first transmitting unit is larger than the capable transmission distance of the second transmitting unit. The processing unit is coupled to the first transmitting unit and the second transmitting unit. The processing unit transmits the control signal through the second transmitting unit to the wireless receiver when the strength of the responding signal is at a high intensity range. The processing unit transmits the control signal through the first transmitting unit to the wireless receiver when the strength of the responding signal is at a low intensity range.

### BACKGROUND OF THE INVENTION

1. Field of the Invention

The instant disclosure relates to a peripheral device; in particular, to a peripheral device with multi-transmission capability.

2. Description of Related Art

According to wireless communication technology, the peripheral device of the present electronic device (such as a computer) can wirelessly communicate with the electronic device itself. The peripheral device can transmit signal to the electronic device wirelessly, or the peripheral device can receive signal from the electronic device wirelessly. The mentioned peripheral device can be a mouse, a keyboard or a gamepad . . . etc. When a user manipulates the peripheral device, the peripheral device wirelessly transmits the control signal to the electronic device. The electronic device usually built in or having an external wireless receiver for receiving the control signal from the peripheral device.

Existing wireless communication technology includes Bluetooth, WiFi, Zigbee or Near Field Communication (NFC) . . . etc. Different wireless communication technologies have different signal transmission distance. For example, the communication distance of Bluetooth ranges from 1 meter to 10 meters. The NFC technology usually utilized for wirelessly exchanging information within tens of centimeters.

### SUMMARY OF THE INVENTION

The object of the instant disclosure is to provide a peripheral device with multi-transmission capability. The peripheral device wirelessly transmits a control signal to a wireless receiver.

In order to achieve the aforementioned objects, according to an embodiment of the instant disclosure, a wireless peripheral device with multi-transmission capability is offered. The wireless peripheral device with multi-transmission capability wirelessly transmits a control signal to a wireless receiver. The wireless peripheral device comprises a first wireless transmitting unit, a second wireless transmitting unit and a processing unit. The second wireless transmitting unit receives a responding signal from the wireless receiver. The capable transmission distance of the first wireless transmitting unit is larger than the capable transmission distance of the second wireless transmitting unit. The processing unit is coupled to the first wireless transmitting unit and the second wireless transmitting unit, and selectively transmits the control signal to the wireless receiver through the first wireless transmitting unit or the second wireless transmitting unit according to the responding signal. The processing unit transmits the control signal to the wireless receiver through the second wireless transmitting unit when the signal strength of the responding signal is in a high intensity range. The processing unit transmits the control signal to the wireless receiver through the first wireless transmitting unit when the signal strength of the responding signal is in a low intensity range.

In order to achieve the aforementioned objects, according to an embodiment of the instant disclosure, a wireless peripheral device with multi-transmission capability is offered. The wireless peripheral device with multi-transmission capability wirelessly transmits a control signal to a wireless receiver. The wireless peripheral device comprises a first wireless transmitting unit, a second wireless transmitting unit, a switch and a processing unit. The second wireless transmitting unit receives a responding signal from the wireless receiver. The capable transmission distance of the first wireless transmitting unit is larger than the capable transmission distance of the second wireless transmitting unit. The processing unit is coupled to the switch, the first wireless transmitting unit, and the second wireless transmitting unit. The processing unit transmits the control signal to the wireless receiver through the first wireless transmitting unit or the second wireless transmitting unit according to the setting of the switch.

In summary, a wireless peripheral device with multi-transmission capability is offered. The wireless peripheral device with multi-transmission capability selectively transmits the control signal to the wireless receiver through the first wireless transmitting unit or the second wireless transmitting unit according to the strength of the responding signal or the setting of the switch.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a block diagram of a wireless peripheral device with multi-transmission capability according to a first embodiment of the instant disclosure;

FIG. 2A shows a schematic diagram of a wireless peripheral device with multi-transmission capability transmitting a control signal through a second wireless transmitting unit according to an embodiment of the instant disclosure;

FIG. 2B shows a schematic diagram of a wireless peripheral device with multi-transmission capability transmitting a control signal through a first wireless transmitting unit according to an embodiment of the instant disclosure;

FIG. 3 shows a block diagram of a wireless peripheral device with multi-transmission capability according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

Please refer to FIG. 1 showing a block diagram of a wireless peripheral device with multi-transmission capability according to a first embodiment of the instant disclosure. The wireless peripheral device with multi-transmission capability 1 (hereinafter referred to as the wireless peripheral device) wirelessly transmits a control signal to a wireless receiver. The wireless peripheral device 1 could be a wireless mouse, a wireless keyboard or a wireless gamepad . . . etc. The wireless peripheral device 1 comprises a first wireless transmitting unit 11, a second wireless transmitting unit 12, a processing unit 13, an input unit 14, a memorizing unit 15, a power storing unit 16 and a display unit 17. A wireless receiver 21 could generate a responding signal S. In the present embodiment, the wireless receiver 21 is a transceiver.

The processing unit 13 is coupled to the first wireless transmitting unit 11, the second wireless transmitting unit 12, the input unit 14, the memorizing unit 15, the power storing unit 16 and the display unit 17. The power storing unit 16 is coupled to the second wireless transmitting unit 12.

The second wireless transmitting unit 12 receives the responding signal S from the wireless receiver 21. The capable transmission distance of the first wireless transmitting unit 11 is larger than the capable transmission distance of the second transmitting unit 12. In the present embodiment, the first wireless transmitting unit 11 is a Bluetooth transmitting unit, a WiFi transmitting unit or a Zigbee transmitting unit. The second wireless transmitting unit 12 is a Near Field Communication (NFC) transmitting unit. However, the first wireless transmitting unit 11 and the second wireless transmitting unit 12 of the present invention are not restricted thereto. As long as the capable transmission distance of the first wireless transmitting unit 11 is larger than that of the second transmitting unit 12.

The input unit 14 generates the control signal, the control signal varies depending on the type of the input unit 14. For example, when the wireless peripheral device 1 is a mouse, the input unit 14 may be a trackball of the mouse, an optical sensing element or a button on the mouse. The trackball or the optical sensing element could generate a cursor signal, and the button could generate a button signal. When the wireless peripheral device 1 is a keyboard, the input unit 14 may be a key on the keyboard.

The processing unit 13 selectively transmits the control signal to the wireless receiver 21 through the first wireless transmitting unit 11 or the second wireless transmitting unit 12 according to the responding signal S. The processing unit 13 transmits the control signal to the wireless receiver 21 through the second wireless transmitting unit 12 when the signal strength of the responding signal S is in a high intensity range. The high intensity range is a range that the signal strength of the responding signal S higher than a first threshold value. The distance between the wireless peripheral device 1 and the wireless receiver 21 affects the signal strength of the responding signal S received by the second wireless transmitting unit 12. When the distance between the wireless peripheral device 1 and the wireless receiver 21 is larger (or less), the signal strength of the responding signal S would be weaker (or stronger). In other words, a high intensity range could be predetermined, and when the signal strength of the responding signal S is in the high intensity range, it means that the distance between the wireless peripheral device 1 and the wireless receiver 21 is short enough, such that the wireless peripheral device 1 could utilize the second wireless transmitting unit 12 to exchange information with the wireless receiver 21.

The processing unit 13 transmits the control signal to the wireless receiver 21 through the first wireless transmitting unit 11 when the signal strength of the responding signal S is in a low intensity range. The low intensity range is a range that the signal strength of the responding signal S lower than a second threshold value, the first threshold value and the second threshold value are independent of each other. The first threshold value may be larger than the second threshold value, or the first threshold value may be equal to the second threshold value. In other words, a low intensity range could be predetermined, and when the signal strength of the responding signal S is in the low intensity range, it means that the distance between the wireless peripheral device 1 and the wireless receiver 21 is not short enough, such that the wireless peripheral device 1 utilizing the second wireless transmitting unit 12 could not exchange information with the wireless receiver 21.

The memorizing unit 15 may pre-store a first identification information. When the signal strength of the responding signal S is in the low intensity range, the first wireless transmitting unit 11 may process a wireless link with the wireless receiver 21 according to the first identification information. On the other hand, the first identification information may also be offered by the wireless receiver 21, and the processing unit 13 controls the second wireless transmitting unit 12 to receive the first identification information coming from the wireless receiver 21, and then the processing unit 13 stores the first identification information to the memorizing unit 15. In other words, the wireless link between the first wireless transmitting unit 11 and the wireless receiver 21 could be established according to the first identification information. Conventionally, when utilizing wireless technology, such as Bluetooth, to configure the link between the first wireless transmitting unit 11 and the wireless receiver 21, a pairing process have to be conducted. The mentioned pairing process usually carried out with a manual pressing of a button, manipulating a switch or entering the pairing code. However, in the preset embodiment, the first identification information could be directly used by the wireless receiver 21 for identification of the first wireless transmitting unit 11, such that the manual pairing or configuration could be neglected. The wireless link manner of the first wireless transmitting unit 11 or the second transmitting unit 12 with the wireless receiver 21 are described as follows with of an actual use situation of the user.

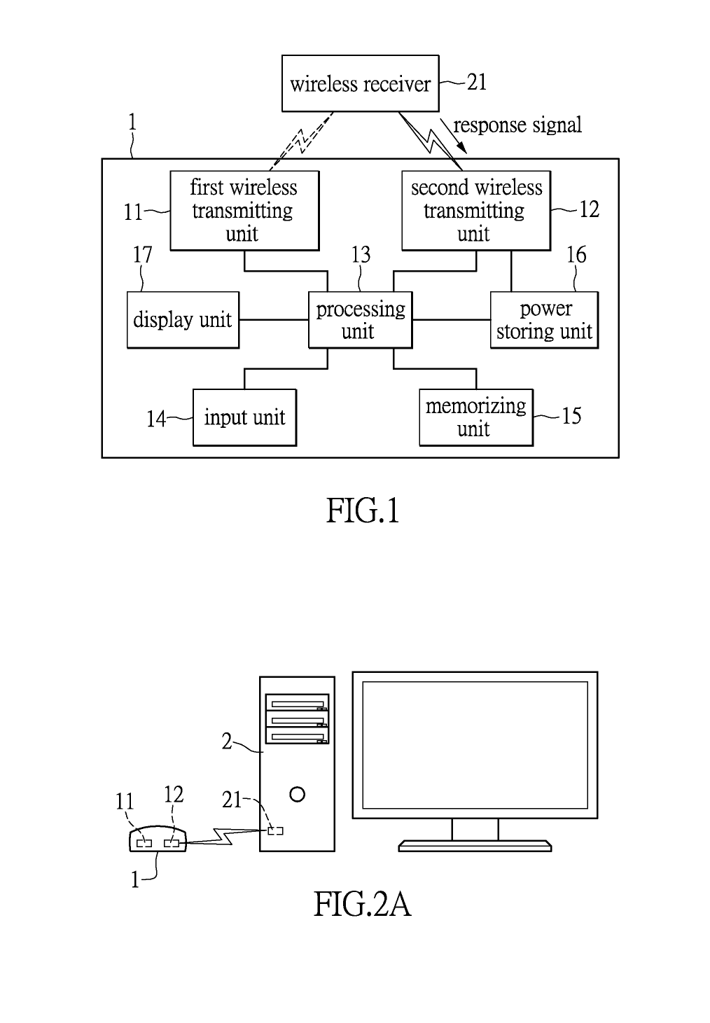

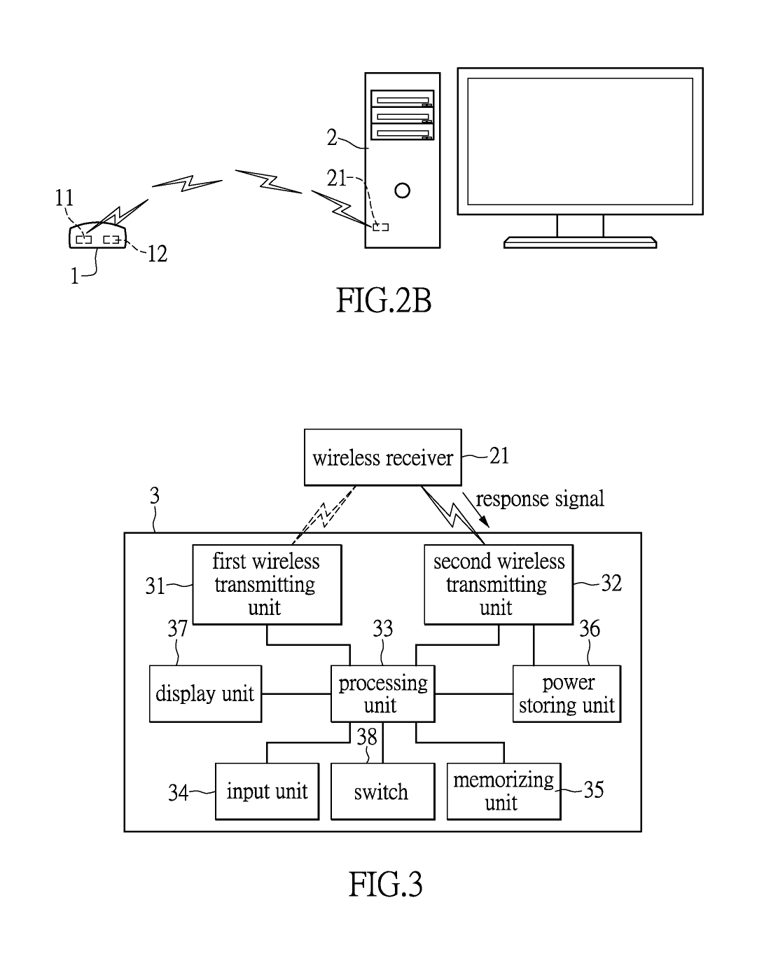

Please refer to FIG. 2A showing a schematic diagram of a wireless peripheral device with multi-transmission capability transmitting a control signal through a second wireless transmitting unit according to an embodiment of the instant disclosure. The wireless receiver 21 is installed to a computer 2. The distance between the wireless peripheral device 1 and the wireless receiver 21 is short enough, such that the signal strength of the responding signal S is in a high intensity range. The processing unit 13 makes the control signal be transmitted to the wireless receiver 21 through the second wireless transmitting unit 12. Meanwhile, although the first wireless transmitting unit 11 may also be linked with the wireless receiver, but the wireless peripheral device 1 exchanges information with the wireless receiver 21 through the second wireless transmitting unit 12. The first identification information stored in the memorizing unit 15 is coming from the wireless receiver 21 and the first identification information is for the identification process of wireless linking the first wireless transmitting unit 12 and the wireless receiver 21. The processing unit 13 of the wireless peripheral device 1 controls the second wireless transmitting unit 12 to receive the first identification information coming from the wireless receiver 21, then the processing unit 13 stores the first identification information to the memorizing unit 15. Therefore, the identification process of wireless link between the first wireless transmitting unit 11 and the wireless receiver 21 may be simplified according to the first identification information received by the second wireless transmitting unit 12. The first wireless transmitting unit 11 may provide the first identification information to the wireless receiver 21, in which the first identification information is obtained by the second wireless transmitting unit 12 previously. On the other hand, the memorizing unit 15 may also store a second identification information, when the second wireless transmitting unit 12 is a Near Field Communication (NFC) transmitting unit, the second identification information is a Near Field Communication Tag (NFC Tag) of the second wireless transmitting unit 12. The NFC Tag could make the second wireless transmitting unit 12 be linked to the wireless receiver 21 directly without any manual setting, such that the rapid pairing and connection could be accomplished.

Please refer to FIG. 2B showing a schematic diagram of a wireless peripheral device with multi-transmission capability transmitting a control signal through a first wireless transmitting unit according to an embodiment of the instant disclosure. When the distance between the wireless peripheral device 1 and the wireless receiver 21 is not short enough, such that the responding signal S is in the low intensity range, meanwhile the wireless peripheral device 1 utilizes the first wireless transmitting unit 11 to exchange information with the wireless receiver. Further, the second wireless transmitting unit 12 may receive the information of any near-field wireless device (not shown in FIG. 2B) neighboring to the wireless peripheral device 1, and the processing unit controls the first wireless transmitting unit 11 to transmit the information of the near-field wireless device to the wireless receiver 21. In other words, the wireless receiver 21 may receive the information of the near-filed wireless device near to the wireless peripheral device 1 by the first wireless transmitting unit 11. Thus, the problem that the capable transmission distance is not enough could be solved. Meanwhile, the wireless peripheral device 1 is a reading means, such that the wireless receiver 21 may read the information of the near-field wireless device far away from the wireless receiver 21 but neighboring to the wireless peripheral device 1.

Referring to FIG. 1 again. The power storing unit 16 is coupled to the second wireless transmitting unit 12. The second wireless transmitting unit 12 may transmit an electrical power to the power storing unit, and the electrical power is coming from the wireless receiver 21 through near-field electromagnetic field. That is, the wireless receiver 21 may charge the wireless peripheral device 1 through the second wireless transmitting unit 12. Further, the processing unit 13 determines whether the electrical power stored in the power storing unit 16 is lower than a power threshold value. The processing unit 13 controls the display unit 17 to display a low power indicating signal when the electrical power stored in the power storing unit 16 is lower than the power threshold value. The display unit 17 may be a light-emitting element such as a light-emitting-diode (LED), or an image displaying element such as a liquid crystal display (LCD). When the electrical power stored in the power storing unit 16 of the wireless peripheral device 1 is not enough, the display unit 17 may prompt the user with a visual manner. For example, displaying the low power indicating signal of the display unit 17 could be accomplished by light-emitting of the LED or image-displaying of the LCD.

Please refer to FIG. 3 showing a block diagram of a wireless peripheral device with multi-transmission capability according to another embodiment of the instant disclosure. The wireless peripheral device 3 transmits a control signal to a wireless receiver 21. The wireless peripheral device 3 comprises a first wireless transmitting unit 31, a second wireless transmitting unit 32, a processing unit 33, an input unit 34, a memorizing unit 35, a power storing unit 36, a display unit 37 and a switch 38. The second wireless transmitting unit 32 receives the responding signal S coming from the wireless receiver 21. The capable transmission distance of the first wireless transmitting unit 32 is larger than the capable transmission distance of the second wireless transmitting unit 32. The wireless peripheral device 3 of the present embodiment is significantly identical to the embodiment shown in FIG. 1 except for differences specified in the follows. The wireless peripheral device 3 comprises the switch 38 coupled to the processing unit 33. The processing unit 33 transmits the control signal to the wireless receiver 21 through the first wireless transmitting unit 31 or the second wireless transmitting unit 32 according to the setting of the switch 38. In other words, by setting the switch 38, the user manipulating the wireless peripheral device 3 could select the first wireless transmitting unit 31 or the second wireless transmitting unit 32 to transmit the control signal to the wireless receiver 21. Other elements of the wireless peripheral device 3 is the same as to that of the wireless peripheral device 1 in the previous embodiment, thus the redundant information is not repeated.

In summary, the peripheral device with multi-transmission capability offered in the embodiments may select the first wireless transmitting unit or the second wireless transmitting unit to transmit the control signal to the wireless receiver according to the signal strength of the responding signal or the setting of the switch. The first identification information received through the second wireless transmitting unit may be used to the identification process of linking between the first wireless transmitting unit and the wireless receiver. Additionally, when the wireless peripheral device is far away from the wireless receiver and the first wireless transmitting unit is wireless linking to the wireless receiver, the information of the near-field wireless device received (or read) by the second wireless transmitting unit may be transmitted to the wireless receiver through the first wireless transmitting unit.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A wireless peripheral device with multi-transmission capability, wirelessly transmitting a control signal to a wireless receiver, the wireless peripheral device comprising:
a first wireless transmitting unit;
a second wireless transmitting unit, receiving a responding signal from the wireless receiver, wherein the capable transmission distance of the first wireless transmitting unit is larger than the capable transmission distance of the second wireless transmitting unit; and
a processing unit, coupled to the first wireless transmitting unit and the second wireless transmitting unit, selectively transmitting the control signal to the wireless receiver through the first wireless transmitting unit or the second wireless transmitting unit according to the responding signal;
wherein the processing unit transmits the control signal to the wireless receiver through the second wireless transmitting unit when the signal strength of the responding signal is in a high intensity range, the processing unit transmits the control signal to the wireless receiver through the first wireless transmitting unit when the signal strength of the responding signal is in a low intensity range.

2. The wireless peripheral device with multi-transmission capability according to claim 1, further comprising:
an input unit, generating the control signal.

3. The wireless peripheral device with multi-transmission capability according to claim 2, wherein the wireless peripheral device is a wireless mouse or a wireless keyboard.

4. The wireless peripheral device with multi-transmission capability according to claim 1, further comprising:
a memorizing unit, storing a first identification information;
wherein the first wireless transmitting unit processes wireless links with the wireless receiver according to the first identification information when the signal strength of the responding signal is in the low intensity range.

5. The wireless peripheral device with multi-transmission capability according to claim 4, wherein the first identification information is provided by the wireless receiver, the processing unit controls the second wireless transmitting unit to receive the first identification information from the wireless receiver.

6. The wireless peripheral device with multi-transmission capability according to claim 1, wherein the first wireless transmitting unit is a Bluetooth transmitting unit, a WiFi transmitting unit or a Zigbee transmitting unit.

7. The wireless peripheral device with multi-transmission capability according to claim 1, wherein the second wireless transmitting unit is a NFC (Near Field Communication) transmitting unit.

8. The wireless peripheral device with multi-transmission capability according to claim 7, further comprising:
a power storing unit, coupled to the second wireless transmitting unit;
wherein the second wireless transmitting unit transmits an electrical power to the power storing unit, the electrical power is coming from the wireless receiver through near-field electromagnetic field.

9. The wireless peripheral device with multi-transmission capability according to claim 8, further comprising:
a display unit, coupled to the processing unit;
wherein the processing unit determines whether the electrical power stored in the power storing unit is lower than a power threshold value, the processing unit controls the display unit to display a low power indicating signal when the electrical power stored in the power storing unit is lower than the power threshold value.

10. The wireless peripheral device with multi-transmission capability according to claim 4, wherein the memorizing unit further storing a second identification information, the second identification information is an Near Field Communication Tag (NFC Tag) of the second wireless transmitting unit.

11. The wireless peripheral device with multi-transmission capability according to claim 7, wherein the second wireless transmitting unit receives the information of a near-field wireless device, the processing unit controls the first wireless transmitting unit to transmit the information of the near-field wireless device to the wireless receiver.

12. The wireless peripheral device with multi-transmission capability according to claim 1, wherein the high intensity range is a range that the signal strength of the responding signal higher than a first threshold value, the low intensity range is a range that the signal strength of the responding signal lower than a second threshold value, the first threshold value and the second threshold value are independent of each other.

13. The wireless peripheral device with multi-transmission capability according to claim 12, wherein the first threshold value is equal to the second threshold value.

14. A wireless peripheral device with multi-transmission capability, wirelessly transmitting a control signal to a wireless receiver, the wireless peripheral device comprising:
a first wireless transmitting unit;
a second wireless transmitting unit, receiving a responding signal from the wireless receiver, wherein the capable transmission distance of the first wireless transmitting unit is larger than the capable transmission distance of the second wireless transmitting unit;
a switch; and
a processing unit, coupled to the switch, the first wireless transmitting unit, and the second wireless transmitting unit, wherein the processing unit transmits the control signal to the wireless receiver through the first wireless transmitting unit or the second wireless transmitting unit according to the setting of the switch.

15. The wireless peripheral device with multi-transmission capability according to claim 14, further comprising:
an input unit, generating the control signal.

16. The wireless peripheral device with multi-transmission capability according to claim 15, wherein the wireless peripheral device is a wireless mouse or a wireless keyboard.

17. The wireless peripheral device with multi-transmission capability according to claim 14, further comprising:
a memorizing unit, storing a first identification information;
wherein the first wireless transmitting unit processes wireless links with the wireless receiver according to the first identification information when the signal strength of the responding signal is in a low intensity range, wherein the low intensity range is a range that the signal strength of the responding signal lower than a second threshold value.

18. The wireless peripheral device with multi-transmission capability according to claim 17, wherein the first identification information is provided by the wireless receiver, the processing unit controls the second wireless transmitting unit to receive the first identification information coming from the wireless receiver.

19. The wireless peripheral device with multi-transmission capability according to claim 14, wherein the first wireless transmitting unit is a Bluetooth transmitting unit, a WiFi transmitting unit or a Zigbee transmitting unit.

20. The wireless peripheral device with multi-transmission capability according to claim 14, wherein the second wireless transmitting unit is a Near-Field Communication (NFC) transmitting unit.

21. The wireless peripheral device with multi-transmission capability according to claim 20, further comprising:
a power storing unit, coupled to the second wireless transmitting unit;
wherein the second wireless transmitting unit transmits an electrical power to the power storing unit, the electrical power is coming from the wireless receiver through near-field electromagnetic field.

22. The wireless peripheral device with multi-transmission capability according to claim 17, wherein the memorizing unit further storing a second identification information, the second identification information is an Near Field Communication Tag (NFC Tag) of the second wireless transmitting unit.

23. The wireless peripheral device with multi-transmission capability according to claim 21 further comprising:
a display unit, coupled to the processing unit;
wherein the processing unit determines whether the electrical power stored in the power storing unit is lower than a power threshold value, the processing unit controls the display unit to display a low power indicating signal when the electrical power stored in the power storing unit is lower than the power threshold value.

24. The wireless peripheral device with multi-transmission capability according to claim 20, wherein the second wireless transmitting unit receives the information of a near-field wireless device, the processing unit controls the first wireless transmitting unit to transmit the information of the near-field wireless device to the wireless receiver.
